(19) United States
(12) Patent Application Publication
(10) Pub. No.: US 2026/0185575 A1
(43) Pub. Date: Jul. 2, 2026

(54) BRAKE DISC AND PREPARATION METHOD, BRAKE SYSTEM, AND VEHICLE

(71) Applicant: BYD COMPANY LIMITED, Shenzhen (CN)

(72) Inventors: Xinping LIN, Shenzhen (CN); Qingping YANG, Shenzhen (CN); Pinyi JIANG, Shenzhen (CN); Shun ZHAO, Shenzhen (CN)

(73) Assignee: BYD COMPANY LIMITED, Shenzhen (CN)

(21) Appl. No.: 19/546,725

(22) Filed: Feb. 23, 2026

Related U.S. Application Data
(63) Continuation of application No. PCT/CN2024/079331, filed on Feb. 29, 2024.

(30) Foreign Application Priority Data
Aug. 24, 2023 (CN) 202311088529.9

(51) Int. Cl. F16D 65/12

(52) U.S. Cl. CPC F16D 65/126; F16D 2200/0047; F16D 2200/0052; F16D 2200/006; F16D 2200/0086

(57) ABSTRACT

A brake disc and a preparation method, a brake system, and a vehicle. The brake disc comprises a dense region and a plurality of nanoporous regions distributed at intervals in the dense region, wherein the dense region comprises a carbon fiber reinforced silicon carbide material, and the nanoporous region comprises pyrolytic carbon in a continuous phase and carbon particles distributed in the pyrolytic carbon, wherein the pore size of the nanoporous region ranges from about 10 nm to about 100 nm, and the porosity ranges from about 15% to about 30.

### CROSS-REFERENCE TO RELATED APPLICATIONS

This application claims the benefit of International Application No. PCT/CN2024/079331, filed on Feb. 29, 2024, which claims priority to Chinese Patent Application No. 202311088529.9, filed on Aug. 24, 2023. The disclosures of the prior applications are incorporated herein by reference in their entirety.

### TECHNICAL FIELD

This application relates to the field of brake material technology, and more particularly to a brake disc, a manufacturing method therefor, a braking system, and a transportation means.

### BACKGROUND

Carbon ceramic brake discs have gained popularity in the market due to their superior performance. A material of the carbon ceramic brake disc generally includes carbon fiber-reinforced silicon carbide/elemental silicon, where carbon fiber provides toughness and silicon carbide provides abrasion resistance. A continuous phase formed by the two brittle materials, silicon carbide and free silicon, may generate a crack under an external force. The generated crack may extend to an interface between the carbon fiber and a continuous phase material, leading to a long crack in the brake disc. Under long-term alternating load, a penetrating crack may be formed in the brake disc, which can result in breaking of the brake disc and adversely affect a service life of the carbon ceramic brake disc.

### SUMMARY

In view of this, the present disclosure provides a brake disc. A nanoporous area in the brake disc can improve toughness of the brake disc, which can prolong a service life of the carbon ceramic brake disc.

A first aspect of the present disclosure provides a brake disc, including a dense area and a plurality of nanoporous areas spaced apart in the dense area. The dense area includes a carbon fiber-reinforced silicon carbide material. The nanoporous area includes pyrolytic carbon in a continuous phase and carbon particles distributed in the pyrolytic carbon. A pore size of a nanopore of the nanoporous area ranges from about 10 nm to about 100 nm, and porosity of the nanoporous area ranges from about 15% to about 30%.

A nanoporous structure of the nanoporous area makes the nanoporous area more porous at a nanoscale than the dense area. In addition, an interfacial bonding force between the pyrolytic carbon and the carbon particles is weaker. When the brake disc is subject to an external force, a crack is generated in the dense area, and the crack extends to the nanoporous area and extends along an interface of the pyrolytic carbon/interfaces of the carbon particles in the nanoporous area. This extension process is also an energy absorption process of the crack. Therefore, the crack may gradually disappear. In this way, toughness of the brake disc can be improved, and a service life of the brake disc can be prolonged.

In an implementation, a size of the nanoporous area ranges from about 30 μm to about 500 μm.

In an implementation, based on a volume of the brake disc, a sum of volume percentages of the plurality of nanoporous areas ranges from about 5% to about 30%.

In an implementation, based on a total mass of the nanoporous area, the nanoporous area includes about 30% to about 70% carbon particles, about 10% to about 40% pyrolytic carbon, and 0% to about 50% silicon carbide particles.

In an implementation, a mass percentage of the silicon carbide particles in the nanoporous area ranges from about 5% to about 50%.

In an implementation, a particle size of the carbon particle ranges from about 0.1 μm to about 10 μm.

In an implementation, a D50 particle size of the carbon particle ranges from about 0.3 μm to about 10 μm.

In an implementation, a D50 particle size of the silicon carbide particle ranges from about 0.3 μm to about 20 μm.

In an implementation, porosity of the brake disc ranges from about 1% to about 5%.

A second aspect of the present disclosure provides a manufacturing method for a brake disc. The method includes immersing a carbon fiber tow in a solution of first resin, taking out the carbon fiber tow, and drying, curing, and cutting the carbon fiber tow, to obtain carbon fiber-reinforced resin strips, heating and pressurizing a first raw material including carbon particles and second resin powder in a mold for curing, and then crushing and sieving the first raw material to obtain a granular second raw material, mixing, heating, and stirring the carbon fiber-reinforced resin strips, the second raw material, third resin powder, and a solvent until the solvent volatilizes, to obtain a mixture; and crushing and sieving the mixture, transferring the mixture to a mold, and heating and pressurizing the mixture for curing, to obtain a brake disc blank, where the brake disc blank includes a first material distribution area and a plurality of second material distribution areas spaced apart in the first material distribution area, the first material distribution area includes the carbon fiber-reinforced resin strips and the third resin powder, and the second material distribution area includes the second raw material and the third resin powder, and performing carbonization treatment on the brake disc blank under a protective atmosphere, and performing siliconizing treatment, to obtain the brake disc.

The brake disc includes a dense area and a plurality of nanoporous areas spaced apart in the dense area. The dense area includes a carbon fiber-reinforced silicon carbide material. The nanoporous area includes pyrolytic carbon in a continuous phase and carbon particles distributed in the pyrolytic carbon. A pore size of the nanoporous area ranges from about 10 nm to about 100 nm, and porosity of the nanoporous area ranges from about 15% to about 30%. The manufacturing method has simple steps, strong process reliability, and high production efficiency, which can enable large-scale industrial production.

In an implementation, based on total mass of the mixture, the mixture includes about 20% to about 50% carbon fiber-reinforced resin strips, about 20% to about 40% second raw material, and about 20% to about 40% third resin powder.

In an implementation, a length of the carbon fiber-reinforced resin strip ranges from about 0.5 cm to about 3 cm.

In an implementation, based on total mass of the first raw material, the first raw material includes about 30% to about 60% carbon particles, about 20% to about 50% second resin powder, and 0% to about 40% silicon carbide particles.

In an implementation, the sieving the first raw material is performed by using a sieve with about 50 to about 400 meshes.

In an implementation, the sieving the mixture is performed by using a sieve with about 15 to about 30 meshes.

A third aspect of the present disclosure provides a braking system, including the brake disc provided in the first aspect of the present disclosure. Because the carbon ceramic brake disc provided in the first aspect of the present disclosure is used, the braking system can have good braking effect, high reliability, and a longer service life.

In an implementation, the braking system includes the carbon ceramic brake disc, a brake caliper bracket, a brake caliper housing, and a friction plate.

A fourth aspect of the present disclosure provides a transportation means, including the braking system provided in the third aspect of the present disclosure. Because the transportation means has the braking system provided in the third aspect of the present disclosure, the transportation means can have good market competitiveness.

In an implementation, the transportation means includes a vehicle or an airplane, and the vehicle includes an automobile or a rail transit train.

### BRIEF DESCRIPTION OF DRAWINGS

Aspects of the present disclosure can be understood from the following detailed description when read with the accompanying figures. It is noted that, in accordance with the standard practice in the industry, various features are not drawn to scale. In fact, the dimensions of the various features may be increased or reduced for clarity of discussion.

FIG. 1 is a simplified diagram of a structure of any area on any cross section of a brake disc according to an embodiment of the present disclosure.

FIG. 2 is a scanning electron microscope (SEM) image of a cross section of a brake disc obtained in a second embodiment of the present disclosure.

### DETAILED DESCRIPTION

Detailed descriptions and technical contents of the present invention are illustrated below in conjunction with the accompanying drawings. However, it is to be understood that the descriptions and the accompanying drawings disclosed herein are merely illustrative and exemplary and not intended to limit the scope of the present invention.

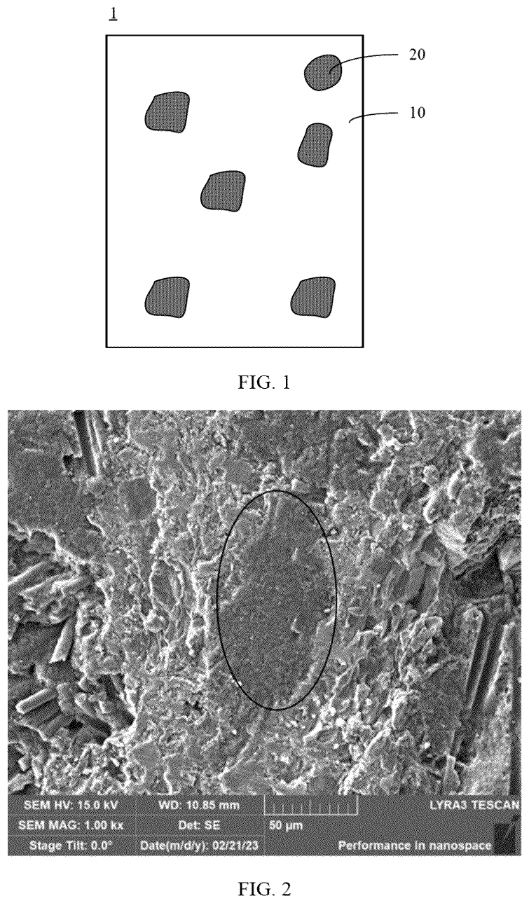

Generally, a carbon ceramic brake disc is directly obtained through a siliconization reaction of carbon fiber/porous carbon. The obtained carbon ceramic brake disc is entirely of a nano-dense structure, which has high brittleness and lacks toughness. After prolonged use, a penetrating crack may appear, which can result in breaking of the carbon ceramic brake disc and adversely affect a service life of the carbon ceramic brake disc. To address the foregoing technical problem, embodiments of the present disclosure provide a brake disc. FIG. 1 is a simplified diagram of a structure of any area on any cross section of a brake disc according to an embodiment of the present disclosure. As shown in FIG. 1, the brake disc 1 includes a dense area 10 and a plurality of nanoporous areas 20 spaced apart in the dense area 10. In some implementations, the nanoporous area 20 is surrounded by the dense area 10.

The dense area 10 includes a carbon fiber-reinforced silicon carbide material. The nanoporous area 20 includes pyrolytic carbon in a continuous phase and carbon particles distributed in the pyrolytic carbon. A pore size of the nanoporous area 20 ranges from about 10 nm to about 100 nm, and porosity of the nanoporous area ranges from about 15% to about 30%. The dense area 10 includes a continuous phase of the silicon carbide material and a carbon fiber reinforcement distributed in the continuous phase. The pore size means a pore size of a nanopore in the nanoporous area 20.

Carbon fiber in the dense area can provide toughness for the brake disc. However, based on a use characteristic of the brake disc, a large amount of silicon carbide may be needed to serve as the continuous phase in the dense area. As a result, the dense area of the brake disc is still dominated by brittleness and lacks toughness. In addition, a nanoporous structure distributed in the nanoporous area of the dense area makes the nanoporous area more porous at a nanoscale than the dense area. Furthermore, materials of the nanoporous area are mainly the pyrolytic carbon and the carbon particles, and an interfacial bonding force between the two materials is weak. When a braking system is started, a friction plate in the braking system clamps the brake disc, so that the brake disc and the friction plate rub against each other to implement braking. After the foregoing process is repeated for a plurality of times, a crack is generated in the dense area of the brake disc. In the brake disc provided in the present disclosure, after the crack is generated, the crack extends to the nanoporous area and extends along an interface of the pyrolytic carbon/interfaces of carbon particles in the nanoporous area. In the foregoing process, energy of the crack is gradually absorbed by the nanoporous structure of the nanoporous area. Therefore, the crack generated in the dense area may gradually disappear. In this way, toughness of the brake disc can be improved, and a service life of the brake disc can be prolonged.

It should be noted that the foregoing comparison between the nanoporous area and the dense area is based on the nanoscale. In the dense area, there may be pores with micrometer-scale pore sizes, which leads to a visual error that “the dense area appears more porous than the nanoporous area” in a SEM image of a cross section of a brake disc sample.

For example, the pore size of the nanoporous area may be about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, or the like. If the pore size of the nanoporous area is excessively small (less than about 10 nm), energy may not be effectively absorbed in a process of crack extension and consequently a matrix may fracture. If the pore size of the nanoporous area is excessively large, the crack may not extend and consequently the dense area may fracture.

For example, the porosity of the nanoporous area may be about 15%, about 16%, about 17%, about 18%, about 19%, about 20%, about 21%, about 22%, about 23%, about 24%, about 25%, about 26%, about 27%, about 28%, about 29%, about 30%, or the like. If the porosity of the nanoporous area is excessively small, there may be insufficient porous areas to absorb energy of the crack and consequently energy cannot be effectively absorbed. If the porosity of the nanoporous area is excessively large, the crack may not extend and consequently the dense area may fracture.

In an implementation, a size of the nanoporous area ranges from about 30 μm to about 500 μm. Understandably, the nanoporous area is of a three-dimensional structure. A circular brake disc is taken as an example to describe the size of the nanoporous area: the disc-shaped brake disc includes an upper surface, a lower surface, and a side surface connecting the upper surface and the lower surface. If the brake disc is cut along any plane, a size of a nanoporous area in the obtained cross section of the brake disc ranges from about 30 μm to about 500 μm. For example, the size of the nanoporous area may be about 30 μm, about 40 μm, about 50 μm, about 60 μm, about 80 μm, about 100 μm, about 120 μm, about 150 μm, about 180 μm, about 200 μm, about 220 μm, about 250 μm, about 280 μm, about 300 μm, about 320 μm, about 350 μm, about 380 μm, about 400 μm, about 420 μm, about 450 μm, about 480 μm, about 490 μm, about 500 μm, or the like. The size of the nanoporous area is controlled within the foregoing range, so that there can be a sufficiently large porous area at the nanoscale to absorb energy of the crack, to improve toughness of the brake disc without affecting strength of the dense area. In this way, braking effect of the brake disc is maintained, and the service life of the brake disc can be prolonged.

In an implementation, based on a total volume of the brake disc, a sum of volume percentages of the plurality of nanoporous areas ranges from about 5% to about 30%. That is, the sum of the volume percentages of all the nanoporous areas in the brake disc ranges from about 5% to about 30%. For example, the sum of the volume percentages of the nanoporous areas may be about 5%, about 8%, about 10%, about 12%, about 15%, about 18%, about 20%, about 22%, about 25%, about 28%, about 30%, or the like. The sum of the volume percentages of the plurality of nanoporous areas in the brake disc is controlled within the foregoing range, so that there are sufficient nanoporous areas spaced apart in the dense area to absorb energy generated by cracks in different positions of the dense area under impact of an external force. This contributes to uniform performance in each position of the brake disc, to better and more comprehensively improve toughness of the brake disc without affecting abrasion resistance and strength of the brake disc.

In an implementation, the nanoporous structure of the nanoporous area is formed by a plurality of stacked carbon particles and the pyrolytic carbon. The plurality of carbon particles are stacked on each other. Understandably, a gap is formed between adjacent carbon particles. The pyrolytic carbon is filled in the gap to form the continuous phase, so as to form the nanoporous structure.

In an implementation, a particle size of the carbon particle in the nanoporous area ranges from about 0.1 μm to about 10 μm. In some embodiments, a D50 particle size of the carbon particle in the nanoporous area ranges from about 0.3 μm to about 10 μm. Controlling the D50 particle size of the carbon particle within the foregoing range is conducive to controlling the pore size of the nanoporous structure within a smaller range, which is more conducive to absorption of energy of the crack. For example, the particle size of the carbon particle in the nanoporous area may be about 0.3 μm, about 0.5 μm, about 1.0 μm, about 2.0 μm, about 3.0 μm, about 4.0 μm, about 5.0 μm, about 6.0 μm, about 7.0 μm, about 8.0 μm, about 9.0 μm, about 10.0 μm, or the like.

In an implementation, a material of the carbon particle in the nanoporous area includes but is not limited to at least one of microcrystalline carbon, graphite, coke, and chopped carbon fiber. For the chopped carbon fiber, the particle size means a length of the chopped carbon fiber. In some embodiments, the length of the chopped carbon fiber ranges from about 14 μm to about 60 μm. For example, the length of the chopped carbon fiber may be about 15 μm, about 20 μm, about 25 μm, about 30 μm, about 35 μm, about 40 μm, about 45 μm, about 50 μm, about 55 μm, about 60 μm, or the like.

In an implementation, the nanoporous area further includes silicon carbide particles. That is, the nanoporous area includes the carbon particles, the pyrolytic carbon, and the silicon carbide particles. In some implementations, the carbon particles and the silicon carbide particles in the nanoporous area are stacked on each other, and the pyrolytic carbon is filled in gaps formed by stacking of the carbon particles and the silicon carbide particles to form the continuous phase, so as to form the nanoporous structure. In this way, the nanoporous area can absorb energy of the crack in the dense area and improve toughness of the brake disc.

In an implementation, a D50 particle size of the silicon carbide particle in the nanoporous area ranges from about 0.3 μm to about 20 μm. Controlling the D50 particle size of the silicon carbide particle within the foregoing range is conducive to controlling the pore size of the nanoporous structure within a smaller range, which is more conducive to absorption of energy of the crack. For example, the D50 particle size of the silicon carbide particle in the nanoporous area may be about 0.3 μm, about 0.5 μm, about 1.0 μm, about 2.0 μm, about 5.0 μm, about 8.0 μm, about 10.0 μm, about 12.0 μm, about 15.0 μm, about 18.0 μm, about 20.0 μm, or the like.

In an implementation, based on total mass of the nanoporous area, the nanoporous area includes about 30% to about 70% carbon particles, about 10% to about 40% pyrolytic carbon, and 0% to about 50% silicon carbide particles. For example, a mass percentage of the carbon particles in the nanoporous area may be about 30%, about 35%, about 40%, about 45%, about 50%, about 55%, about 60%, about 65%, about 70%, or the like; and a mass percentage of the pyrolytic carbon in the nanoporous area may be about 10%, about 15%, about 20%, about 25%, about 30%, about 35%, about 40%, or the like. For example, a mass percentage of the silicon carbide particles in the nanoporous area may be about 1%, about 5%, about 10%, about 15%, about 20%, about 25%, about 30%, about 35%, about 40%, about 45%, about 50%, or the like. In some implementations, the nanoporous area includes about 30% to about 70% carbon particles, about 10% to about 40% pyrolytic carbon, and about 5% to about 50% silicon carbide particles. The mass percentage of each of the foregoing substances is controlled within the foregoing range, so that the pore size and the porosity of the nanoporous structure of the nanoporous area can be controlled, and strength of the nanoporous area can also be considered. In this way, toughness of the brake disc can be improved, and high strength of the brake disc can be maintained.

In an implementation, a length of the carbon fiber in the dense area ranges from about 1 cm to about 2 cm. For example, the length of the carbon fiber in the dense area may be about 1.0 cm, about 1.1 cm, about 1.2 cm, about 1.3 cm, about 1.4 cm, about 1.5 cm, about 1.6 cm, about 1.7 cm, about 1.8 cm, about 1.9 cm, about 2.0 cm, or the like. This can provide mechanical strength of the dense area. In this way, a risk of crack generation in the dense area can be reduced, which can improve braking effect of the brake disc and prolong the service life of the brake disc.

In an implementation, an edge area of the nanoporous area has silicon carbide in a continuous phase.

In an implementation, the dense area further includes free elemental silicon. The elemental silicon and the silicon carbide in the dense area jointly form a continuous phase, and the carbon fiber is distributed in the continuous phase as a reinforcement.

In an implementation, porosity of the brake disc ranges from about 1% to about 5%. Understandably, there may be a micrometer-scale pore size in the dense area. Controlling the overall porosity of the brake disc within the foregoing range is conducive to absorption of the crack in the dense area, which can provide mechanical performance of the dense area and improve performance of the brake disc. For example, the porosity of the brake disc may be about 1.00%, about 1.20%, about 1.40%, about 1.50%, about 1.60%, about 1.70%, about 1.80%, about 1.90%, about 2.00%, about 2.10%, about 2.20%, about 2.30%, about 2.40%, about 2.50%, about 3.0%, about 3.5%, about 4.0%, about 4.5%, about 5.0%, or the like.

Embodiments of the present disclosure further provide a manufacturing method for a brake disc, including the following steps.
S01: Immerse a carbon fiber tow in a solution of first resin, take out the carbon fiber tow, and dry, cure, and cut the carbon fiber tow, to obtain carbon fiber-reinforced resin strips.
S02: Heat and pressurize a first raw material including carbon particles and second resin powder in a mold for curing, and then crush and sieve the first raw material to obtain a granular second raw material. Understandably, in the first raw material, the carbon particles are stacked on each other, and the second resin powder is filled in gaps formed by stacking of the carbon particles. In some implementations of the present disclosure, the carbon particles and the second resin powder are mixed in a solid-phase mixing apparatus. In some embodiments, the carbon particles and the second resin powder are mixed in a V-type mixer.

It should be noted that S01 and S02 are only distinguished in terms of steps, not in terms of their order. During actual production, the carbon fiber-reinforced resin strips may be manufactured first, or the second raw material may be manufactured first; or the second raw material is manufactured first and then the carbon fiber-reinforced resin strips are manufactured; or the carbon fiber-reinforced resin strips and the second raw material are manufactured at the same time.
S03: Mix, heat, and stir the carbon fiber-reinforced resin strips, the second raw material, third resin powder, and a solvent until the solvent volatilizes, to obtain a mixture; and crush and sieve the mixture, transfer the mixture to a mold, and heat and pressurize the mixture for curing, to obtain a brake disc blank, where the brake disc blank includes a first material distribution area and a plurality of second material distribution areas spaced apart in the first material distribution area, the first material distribution area includes the carbon fiber-reinforced resin strips and the third resin powder, and the second material distribution area includes the second raw material and the third resin powder.
S04: Perform carbonization treatment on the brake disc blank under a protective atmosphere, and perform siliconizing treatment, to obtain the brake disc. It should be noted that, in the siliconizing treatment, due to a structural characteristic and a raw material characteristic of the second material distribution area, it may be difficult for elemental silicon to penetrate into the second material distribution area. The carbonization treatment can convert the first resin, the second resin powder, and the third resin powder into pyrolytic carbon, and the siliconizing treatment can cause pyrolytic carbon in the first material distribution area to react with silicon and be converted into silicon carbide. In an implementation, elemental silicon may impregnate a raw material at an edge of the second material distribution area. As a result, the silicon carbide and/or the elemental silicon may exist in an edge area of the nanoporous area in the finally obtained brake disc.

The brake disc includes a dense area and a plurality of nanoporous areas spaced apart in the dense area. The dense area includes a carbon fiber-reinforced silicon carbide material. The nanoporous area includes pyrolytic carbon in a continuous phase and carbon particles distributed in the pyrolytic carbon. A pore size of the nanoporous area ranges from about 10 nm to about 100 nm, and porosity of the nanoporous area ranges from about 15% to about 30%.

In an implementation, the first resin, the second resin powder, and the third resin powder include but are not limited to phenolic resin. In an embodiment, the first resin, the second resin powder, and the third resin powder are thermoplastic phenolic resin.

In an implementation, in step S01, solid content of the solution of the first resin ranges from about 40% to about 60%. In some implementations, the solution of the first resin is a phenolic resin solution with solid content ranging from about 40% to about 60%.

In an implementation, in step S01, the carbon fiber tow impregnated with the solution of the first resin is dried at about 50° C. to about 80° C., cured at about 130° C. to about 160° C., and then cut into the carbon fiber-reinforced resin strips with lengths ranging from about 0.5 cm to about 3 cm. For example, a temperature for drying may be about 50° C., about 55° C., about 60° C., about 65° C., about 70° C., about 75° C., about 80° C., or the like. For example, a temperature for curing may be about 130° C., about 140° C., about 150° C., about 160° C., or the like. For example, the length of the carbon fiber-reinforced resin strip may be about 0.5 cm, about 1.0 cm, about 1.5 cm, about 2.0 cm, about 2.5 cm, about 3.0 cm, or the like. Controlling the length of the carbon fiber-reinforced resin strip within the foregoing range facilitates mixing of the carbon fiber-reinforced resin strips, the second raw material, and the third resin powder.

In an implementation, in step S02, based on total mass of the first raw material, the first raw material includes about 30% to about 60% carbon particles, about 20% to about 50% second resin powder, and 0% to about 40% silicon carbide particles. For example, mass content of the carbon particles in the first raw material may be about 30%, about 35%, about 40%, about 45%, about 50%, about 55%, about 60%, or the like. For example, mass content of the second resin powder in the first raw material may be about 20%, about 25%, about 30%, about 35%, about 40%, about 45%, about 50%, or the like. In some embodiments, the first raw material further includes the silicon carbide particles. In this case, based on the total mass of the first raw material, the first raw material includes about 30% to about 60% carbon particles, about 20% to about 50% second resin powder, and about 10% to about 40% silicon carbide particles. For example, a mass percentage of the silicon carbide particles in the first raw material may be about 10%, about 15%, about 20%, about 25%, about 30%, about 35%, about 40%, or the like. The content of each of the foregoing substances is controlled within the foregoing range, so that toughness and strength of the nanoporous area of the brake disc can be appropriately regulated, and a high dynamic friction coefficient can be achieved. In this way, the brake disc can have improved performance.

In an implementation, in step S02, the first raw material is pressurized at about 130° C. to about 160° C. for curing, to obtain a blocky first raw material. For example, a temperature for pressurization and curing may be about 130° C., about 135° C., about 140° C., about 145° C., about 150° C., about 155° C., about 160° C., or the like.

In an implementation, in step S02, after being crushed, the blocky first raw material is sieved by using a sieve with about 50 to about 400 meshes. For example, a quantity of the meshes of the sieve may be about 50, about 80, about 100, about 120, about 150, about 180, about 200, about 220, about 250, about 280, about 300, about 350, about 380, about 400, or the like. Controlling the quantity of the meshes of the sieve within the foregoing range is conducive to mixing of the second raw material, the carbon fiber-reinforced resin strips, and the third resin powder, which is conducive to regulation of subsequent distribution of the first material distribution area and the second material distribution area, to facilitate regulation of parameters of the nanoporous area of the brake disc.

In an implementation, in step S03, the second raw material, the carbon fiber-reinforced resin strips, the third resin powder, and the solvent are mixed, heated, and stirred, so that the solvent volatilizes completely, where a temperature for heating and stirring ranges from about 50° C. to about 70° C. For example, the temperature for heating and stirring may be about 50° C., about 55° C., about 60° C., about 65° C., about 70° C., or the like. In some implementations of the present disclosure, the solvent includes but is not limited to alcohol.

In an implementation, in step S03, based on total mass of the mixture, the mixture includes about 20% to about 50% carbon fiber-reinforced resin strips, about 20% to about 40% second raw material, and about 20% to about 40% third resin powder. For example, mass content of the carbon fiber-reinforced resin strips in the mixture may be about 20%, about 25%, about 30%, about 35%, about 40%, about 45%, about 50%, or the like. For example, mass content of the second raw material in the mixture may be about 20%, about 25%, about 30%, about 35%, about 40%, or the like. For example, mass content of the third resin powder in the mixture may be about 20%, about 25%, about 30%, about 35%, about 40%, or the like. The mass content of the carbon fiber-reinforced resin strips, the second raw material, and the third resin powder is controlled within the foregoing range, so that a proportion of the nanoporous areas in the brake disc can be controlled within a suitable range. In this way, the brake disc can have good toughness and good strength, so that the obtained brake disc can have both good braking effect and a long service life.

In an implementation, in step S03, after being crushed, the mixture is sieved by using a sieve with about 15 to about 30 meshes. In this way, a particle size of the material can be controlled within a suitable range, and a size of the second material partition in the brake disc blank can be controlled within a suitable range. Based on successful manufacture of the brake disc provided in the present disclosure, a size of the nanoporous area is controlled within a more suitable range, to provide good overall performance of the brake disc.

In an implementation, in step S04, the brake disc blank is kept at a temperature of about 800° C. to about 1200° C. for about 2 hours to about 6 hours under the protective atmosphere. For example, the temperature may be maintained at about 800° C., about 850° C., about 900° C., about 950° C., about 1000° C., about 1050° C., about 1100° C., about 1050° C., about 1200° C., or the like. For example, the temperature may be maintained for about 2 h, about 2.5 h, about 3 h, about 3.5 h, about 4 h, about 4.5 h, about 5 h, about 5.5 h, about 6 h, or the like.

In an implementation, in step S04, the siliconizing treatment may be liquid-phase siliconizing treatment on the brake disc blank.

In an implementation, in step S04, after the siliconizing treatment, post-processing on the brake disc is further included, to obtain a brake disc that meets actual usage requirements. A process for the post-processing includes performing surface grinding on the brake disc.

Embodiments of the present disclosure further provide a braking system, including the brake disc provided in embodiments of the present disclosure. Because the carbon ceramic brake disc provided in the present disclosure is used, the braking system can have good braking effect, high reliability, and a longer service life.

In an implementation, the braking system includes the carbon ceramic brake disc, a brake caliper bracket, a brake caliper housing, and a friction plate.

Embodiments of the present disclosure provide a transportation means, including the braking system provided in the present disclosure. Because the transportation means has the braking system provided in the present disclosure, the transportation means can have good market competitiveness.

In an implementation, the transportation means includes a vehicle or an airplane, and the vehicle includes an automobile or a rail transit train.

The technical solutions of the present disclosure are further described in detail below with reference to a plurality of embodiments.

### Embodiment 1

(1) A 12K carbon fiber tow was immersed in a solution of first resin (phenolic resin) with about 50% solid content. The carbon fiber tow was taken out, dried at about 80° C., cured in an environment of about 150° C., and then cut into carbon fiber-reinforced resin strips with a length of about 2 cm.
(2) Carbon particles (graphite) and second resin powder (phenolic resin) were uniformly mixed in a V-type mixer in a mass ratio of about 50:50, to obtain a first raw material. The first raw material was transferred to a mold and pressurized at about 150° C. for curing, to obtain a blocky first raw material. Then, the blocky first raw material was crushed and sieved by using a sieve with about 100 meshes, to obtain a second raw material.
(3) The carbon fiber-reinforced resin strips, the second raw material, and third resin powder were dispersed in a solvent (alcohol) in a mass ratio of about 40:30:30 and heated and stirred at about 60° C. for about 1 hour so that the solvent volatilized completely, to obtain a mixture. The mixture was crushed and sieved by using a sieve with about 20 meshes. Then, the mixture was transferred to a mold and pressurized at about 150° C. for curing, to obtain a brake disc blank.
(4) The brake disc blank was kept at about 1000° C. for about 4 hours in a nitrogen atmosphere. Then, liquid-phase siliconization was performed on a carbonized brake disc blank. Finally, surface processing was performed, to obtain a brake disc. The brake disc includes a dense area and a plurality of nanoporous areas spaced apart in the dense area.

### Embodiment 2

A difference between Embodiment 2 and Embodiment 1 lies in that in step (2), the first raw material includes the carbon particles, the second resin powder, and silicon carbide particles in a mass ratio of about 30:50:20. A particle size of the silicon carbide particle is about 0.5 μm.

### Embodiment 3

A difference between Embodiment 3 and Embodiment 2 lies in that in step (2), the first raw material includes the carbon particles, the second resin powder, and the silicon carbide particles in a mass ratio of about 60:20:20.

### Embodiment 4

A difference between Embodiment 4 and Embodiment 2 lies in that in step (2), the first raw material includes the carbon particles, the second resin powder, and the silicon carbide particles in a mass ratio of about 30:50:20.

### Embodiment 5

A difference between Embodiment 5 and Embodiment 2 lies in that in step (2), the first raw material includes the carbon particles and the second resin powder in a mass ratio of about 80:20.

### Embodiment 6

A difference between Embodiment 6 and Embodiment 2 lies in that in step (2), the first raw material includes the carbon particles and the second resin powder in a mass ratio of about 20:80.

### Embodiment 7

A difference between Embodiment 7 and Embodiment 2 lies in that in step (3), the mixture includes the carbon fiber-reinforced resin strips, the second raw material, and the third resin powder in a mass ratio of about 20:40:40.

### Embodiment 8

A difference between Embodiment 8 and Embodiment 2 lies in that in step (3), the mixture includes the carbon fiber-reinforced resin strips, the second raw material, and the third resin powder in a mass ratio of about 50:20:30.

### Embodiment 9

A difference between Embodiment 9 and Embodiment 2 lies in that in step (3), the mixture includes the carbon fiber-reinforced resin strips, the second raw material, and the third resin powder in a mass ratio of about 60:10:40.

### Embodiment 10

A difference between Embodiment 10 and Embodiment 2 lies in that in step (3), the mixture includes the carbon fiber-reinforced resin strips, the second raw material, and the third resin powder in a mass ratio of about 10:50:40.

### Embodiment 11

A difference between Embodiment 11 and Embodiment 2 lies in that in step (3), after being crushed, the blocky first raw material was sieved by using a sieve with about 500 meshes; and in step (3), the crushed mixture was sieved by using a sieve with about 50 meshes.

### Embodiment 12

A difference between Embodiment 12 and Embodiment 2 lies in that in step (3), after being crushed, the blocky first raw material was sieved by using a sieve with about 30 meshes; and in step (3), the crushed mixture was sieved by using a sieve with about 10 meshes.

To highlight the beneficial effects of embodiments of the present disclosure, the following comparative example is provided.

### Comparative Example

(1) 12K chopped carbon fiber with a length of about 2 cm, phenolic resin powder, carbon powder, and silicon carbide powder were uniformly mixed, put into a mold, and pressurized for curing, to obtain a molded blank. A mass ratio of carbon fiber:phenolic resin:carbon powder:silicon carbide powder is about 40:45:9:6.
(2) The molded blank was carbonized at a temperature of about 1000° C. for about 4 hours in a nitrogen atmosphere.
(3) Liquid-phase siliconization was performed on a carbonized blank, and processing was performed, to obtain a brake disc.

### Performance Test

(1) Pretreatment was performed on a brake disc sample, to expose a cross section of the brake disc sample. A pore size of a nanoporous area of the brake disc was measured by using a SEM. FIG. 2 shows an SEM image of a cross section of a brake disc in Embodiment 2.
(2) Density and open porosity of the brake disc were measured according to provisions of GB/T 1966.
(3) Bending strength of the brake disc was measured according to provisions of GB/T 6569.
(4) Interlaminar shear strength of the brake disc was measured according to provisions of ASTM D2344/D2344M-13.
(5) Compressive strength of the brake disc was measured according to provisions of GB/T 34559.
(6) Impact toughness of the brake disc was measured according to provisions of GB/T 14389.
(7) Thermal conductivity of the brake disc was tested by using a TC-3000 thermal constant measuring instrument according to provisions of GJ 121.1-91.
(8) A dynamic friction coefficient of the brake disc was tested by using an MM-1000 friction testing machine, where an effective friction surface of a test ring of the MM-1000 friction testing machine was: outer diameter D75 mm/inner diameter D55 mm×10 mm, with pressure of about 98 N/cm², a moment of inertia of about 3 kgf·cm·s², and a linear velocity of about 25 m/s.

TABLE 1

| | | | Average | | | |
|---|---|---|---|---|---|---|
| | Sum of volume | Size range | pore size | Porosity | | Porosity |
| | percentages of | of the | of the | of the | | of the |
| Embodiment | nanoporous areas | nanoporous | nanoporous | nanoporous | Density | brake |
| number | in a brake disc | area/μm | area/nm | area | g/cm³ | disc |
| Embodiment 1 | 10% | 70 to 150 | 45 | 18% | 2.19 | 1.05% |
| Embodiment 2 | 8% | 70 to 150 | 37 | 20% | 2.23 | 0.79% |
| Embodiment 3 | 15% | 100 to 180 | 41 | 23% | 2.15 | 1.86% |
| Embodiment 4 | 15% | 100 to 180 | 38 | 19% | 2.10 | 0.79% |
| Embodiment 5 | 25% | 200 to 350 | 52 | 27% | 2.35 | 2.0% |
| Embodiment 6 | 20% | 200 to 350 | 55 | 29% | 2.40 | 2.5% |
| Embodiment 7 | 14% | 150 to 240 | 43 | 19% | 2.20 | 1.02% |
| Embodiment 8 | 10% | 100 to 180 | 39 | 21% | 2.15 | 0.99% |
| Embodiment 9 | 16% | 100 to 180 | 46 | 25% | 2.06 | 1.06% |
| Embodiment 10 | 30% | 250 to 400 | 34 | 20% | 2.36 | 0.56% |
| Embodiment 11 | 28% | 250 to 400 | 33 | 22% | 2.12 | 0.78% |
| Embodiment 12 | 15% | 150 to 240 | 50 | 18% | 2.33 | 1.33% |
| Comparative | / | / | / | / | 2.17 | 1.03% |
| Example | | | | | | |

TABLE 2

| | Average pore | Porosity | | Porosity | | | | | | |
|---|---|---|---|---|---|---|---|---|---|---|
| | size of a | of the | | of a | Bending | Shear | Compressive | Impact | Thermal | Dynamic |
| Experiment | nanoporous | nanoporous | Density | brake | strength/ | strength/ | strength/ | toughness | conductivity | friction |
| number | area/nm | area/% | g/cm³ | disc | MPa | MPa | MPa | kJ/m² | W/(m · K) | coefficient |
| Embodiment 1 | 45 | 18 | 2.19 | 1.05% | 124.5 | 13.2 | 258.1 | 28.6 | 63.1 | 0.38 |
| Embodiment 2 | 37 | 20 | 2.23 | 0.79% | 130.6 | 16.7 | 263.2 | 26.3 | 62.3 | 0.41 |
| Embodiment 3 | 41 | 23 | 2.15 | 1.86% | 126.0 | 14.5 | 260.3 | 27.5 | 62.4 | 0.42 |
| Embodiment 4 | 38 | 19 | 2.10 | 0.79% | 129.5 | 16.5 | 262.1 | 26.9 | 62.2 | 0.40 |
| Embodiment 5 | 52 | 27 | 2.35 | 2.0% | 94.3 | 8.7 | 183.6 | 23.8 | 42.5 | 0.20 |
| Embodiment 6 | 55 | 29 | 2.40 | 2.5% | 99.2 | 6.5 | 174.0 | 20.4 | 38.6 | 0.31 |
| Embodiment 7 | 43 | 19 | 2.20 | 1.02% | 125.6 | 13.0 | 254.3 | 28.7 | 62.5 | 0.39 |
| Embodiment 8 | 39 | 21 | 2.15 | 0.99% | 160.3 | 15.6 | 255.5 | 27.9 | 62.33 | 0.38 |
| Embodiment 9 | 46 | 25 | 2.06 | 1.06% | 98.8 | 8.5 | 190.3 | 20.4 | 43.8 | 0.24 |
| Embodiment 10 | 34 | 20 | 2.36 | 0.56% | 95.0 | 7.3 | 192.6 | 18.2 | 32.5 | 0.27 |
| Embodiment 11 | 33 | 22 | 2.12 | 0.78% | 90.6 | 8.2 | 180.5 | 22.6 | 39.30 | 0.34 |
| Embodiment 12 | 50 | 18 | 2.33 | 1.33% | 96.4 | 7.9 | 191.4 | 21.7 | 40.03 | 0.28 |
| Comparative | / | / | 2.17 | 1.03% | 82.3 | 9.3 | 224.7 | 13.8 | 59.9 | 0.40 |
| Example | | | | | | | | | | |

It can be seen from the parameters in Table 1 and Table 2 that the impact toughness and the bending strength of brake discs provided in embodiments of the present disclosure are higher than those of the brake disc in the comparative example, and the parameters such as the compressive strength, the shear strength, the thermal conductivity, and the dynamic friction coefficient of the brake discs provided in embodiments also meet usage requirements.

In addition, through comparison between the data of Embodiment 1 and the data of Embodiment 5, it can be found that when a mass ratio of the carbon powder to the second resin powder in the first raw material is within a range further suggested in the present disclosure, performance of the obtained brake disc may be better. Through comparison between the data of Embodiment 1 and the data of Embodiment 2 to Embodiment 4, it can be found that when the first raw material further includes silicon carbide and content of each raw material is within a range further suggested in the present disclosure, mechanical strength and the dynamic friction coefficient of the brake disc can be better. Through comparison between the data of Embodiment 7 and Embodiment 8 and the data of Embodiment 9 and Embodiment 10, it can be found that when content of each substance in the second raw material is within a range further suggested in the present disclosure, the brake disc can perform better overall. Through comparison between the data of Embodiment 2 and the data of Embodiment 11 and Embodiment 12, it can be found that quantities of meshes through which the first raw material and the second raw material were sieved after being crushed also affect performance of the final brake disc. When the quantities of meshes through which the first raw material and the second raw material were sieved after being crushed satisfy parameters further suggested in embodiments of the present disclosure, it may be more likely to obtain a brake disc that has balanced performance and performs better.

The foregoing descriptions are example implementations of the present disclosure. It should be noted that a person of ordinary skill in the art may make several improvements or modifications without departing from the principle of the present disclosure, and the improvements or modifications shall fall within the protection scope of the present disclosure.

Reference numerals: 1: brake disc; 10: dense area; 20: nanoporous area.

What is claimed is:

1. A brake disc, comprising:
a dense area; and
a plurality of nanoporous areas spaced apart in the dense area;
wherein the dense area comprises a carbon fiber-reinforced silicon carbide material, the nanoporous area comprises pyrolytic carbon in a continuous phase and carbon particles distributed in the pyrolytic carbon, a pore size of the nanoporous area ranges from about 10 nm to about 100 nm, and porosity of the nanoporous area ranges from about 15% to about 30%.

2. The brake disc according to claim 1, wherein a size of the nanoporous area ranges from about 30 μm to about 500 μm.

3. The brake disc according to claim 1, wherein based on a volume of the brake disc, a sum of volume percentages of the plurality of nanoporous areas ranges from about 5% to about 30%.

4. The brake disc according to claim 1, wherein based on total mass of the nanoporous area, the nanoporous area comprises about 30% to about 70% carbon particles, about 10% to about 40% pyrolytic carbon, and 0% to about 50% silicon carbide particles.

5. The brake disc according to claim 4, wherein a mass percentage of the silicon carbide particles in the nanoporous area ranges from about 5% to about 50%.

6. The brake disc according to claim 1, wherein a particle size of the carbon particles ranges from about 0.1 μm to about 10 μm.

7. The brake disc according to claim 1, wherein a D50 particle size of the carbon particles ranges from about 0.3 μm to about 10 μm.

8. The brake disc according to claim 4, wherein a D50 particle size of the silicon carbide particles ranges from about 0.3 μm to about 20 μm.

9. The brake disc according to claim 1, wherein porosity of the brake disc ranges from about 1% to about 5%.

10. A manufacturing method for a brake disc, comprising:
immersing a carbon fiber tow in a solution of first resin, taking out the carbon fiber tow, and drying, curing, and cutting the carbon fiber tow, to obtain carbon fiber-reinforced resin strips;
heating and pressurizing a first raw material comprising carbon particles and second resin powder in a mold for curing, and then crushing and sieving the first raw material to obtain a granular second raw material;
mixing, heating, and stirring the carbon fiber-reinforced resin strips, the second raw material, third resin powder, and a solvent until the solvent volatilizes, to obtain a mixture; and crushing and sieving the mixture, transferring the mixture to a mold, and heating and pressurizing the mixture for curing, to obtain a brake disc blank, wherein the brake disc blank comprises a first material distribution area and a plurality of second material distribution areas spaced apart in the first material distribution area, the first material distribution area comprises the carbon fiber-reinforced resin strips and the third resin powder, and the second material distribution area comprises the second raw material and the third resin powder; and
performing carbonization treatment on the brake disc blank under a protective atmosphere, and performing siliconizing treatment, to obtain the brake disc;
wherein the brake disc comprises a dense area and a plurality of nanoporous areas spaced apart in the dense area, the dense area comprises a carbon fiber-reinforced silicon carbide material, the nanoporous area comprises pyrolytic carbon in a continuous phase and carbon particles distributed in the pyrolytic carbon, a pore size of the nanoporous area ranges from about 10 nm to about 100 nm, and porosity of the nanoporous area ranges from about 15% to about 30%.

11. The manufacturing method according to claim 10, wherein based on total mass of the mixture, the mixture comprises about 20% to about 50% carbon fiber-reinforced resin strips, about 20% to about 40% second raw material, and about 20% to about 40% third resin powder; and a length of the carbon fiber-reinforced resin strip ranges from about 0.5 cm to about 3 cm.

12. The manufacturing method according to claim 10, wherein based on total mass of the first raw material, the first raw material comprises about 30% to about 60% carbon particles, about 20% to about 50% second resin powder, and 0% to about 40% silicon carbide particles.

13. The manufacturing method according to claim 10, wherein the sieving of the first raw material to obtain the granular second raw material is performed by using a sieve with about 50 to about 400 meshes.

14. The manufacturing method according to claim 10, wherein the sieving of the mixture is performed by using a sieve with about 15 to about 30 meshes.

15. A braking system having a brake disc, the brake disc comprising:
a dense area; and
a plurality of nanoporous areas spaced apart in the dense area;
wherein the dense area comprises a carbon fiber-reinforced silicon carbide material, the nanoporous area comprises pyrolytic carbon in a continuous phase and carbon particles distributed in the pyrolytic carbon, a pore size of the nanoporous area ranges from about 10 nm to about 100 nm, and porosity of the nanoporous area ranges from about 15% to about 30%.

16. A transportation means including a braking system having a brake disc, the brake disc comprising:
a dense area; and
a plurality of nanoporous areas spaced apart in the dense area;
wherein the dense area comprises a carbon fiber-reinforced silicon carbide material, the nanoporous area comprises pyrolytic carbon in a continuous phase and carbon particles distributed in the pyrolytic carbon, a pore size of the nanoporous area ranges from about 10 nm to about 100 nm, and porosity of the nanoporous area ranges from about 15% to about 30%.
